(19) United States
(12) Patent Application Publication
(10) Pub. No.: US 2002/0013986 A1
(43) Pub. Date: Feb. 7, 2002

(54) Apparatus and method of manufacturing current collector for secondary battery

(76) Inventors: Tae-yong Ahn, Yongin-city (KR); Dong-hoon Lee, Yongin-city (KR); Hak-hyun Lee, Kunpo-city (KR); Yong-nam Kim, Yongin-city (KR)

Correspondence Address: Finnegan, Henderson, Farabow, Garrett & Dunner, L.L.P., 1300 I Street, N.W., Washington, DC, 20005-3315, US

(21) Appl. No.: 09/834,626

(22) Filed: Apr. 16, 2001

(30) Foreign Application Priority Data
Apr. 17, 2000 (KR) 00-20093
Jul. 10, 2000 (KR) 00-39263
Nov. 16, 2000 (KR) 00-68194

(51) Int. Cl. B23P 13/00; B23P 23/00

(52) U.S. Cl. 29/2; 29/730

(57) ABSTRACT

Provided are an apparatus and method for manufacturing a current collector for a secondary battery. In the current collector manufacturing method, a current collector source material is first prepared, pre-treated and then passed between rollers, one of which has patterns shaped like openings to be formed in the source material to then coat a pattern forming composition. Then, the resultant is dried and etched to form the openings, thereby completing the current collector. The current collector manufacturing apparatus includes a main roller, a guide roller coupled to the main roller so that the current collector passes therebetween, and a pattern forming composition storage unit, installed under the main roller, for supplying the pattern forming composition to a patterned portion.

### CROSS-REFERENCE TO RELATED APPLICATIONS

Under the provisions of Section 119 of 35 U.S.C., Applicants hereby claim the benefit of the filing date of Korean Patent Application Numbers 00-20093, filed Apr. 17, 2000; 00-39263 filed Jul. 10, 2000; and 00-68194 filed Nov. 16, 2000; the contents of each of which are incorporated herein by reference in their entirety.

### BACKGROUND OF THE INVENTION

1. Field of the Invention

The present invention relates to an apparatus and method of manufacturing a current collector for a secondary battery, and for forming openings on the current collector.

2. Description of the Related Art

Generally, secondary batteries are capable of charging and discharging and are classified into nickel-cadmium (Ni—Cd) batteries, nickel-hydrogen (Ni—MH) batteries, lithium secondary batteries and so on.

Specifically, there is an ever-increasing demand for the lithium secondary batteries in view of the energy density per unit weight as compared with Ni—Cd or Ni—MH batteries. The lithium secondary batteries are classified into liquid electrolyte batteries and solid electrolyte batteries according to the kind of electrolyte used. In general, a battery that uses a liquid electrolyte is called a lithium ion battery and a battery that uses a polymeric electrolyte is called a lithium polymer battery.

A lithium secondary battery includes a battery unit having a positive plate, a separator and a negative plate sequentially stacked, and a case accommodating the battery unit. Each of the positive and negative electrode plates has a current collector and an active material layer formed on the current collector. A plurality of openings is formed on surfaces of the positive and negative current collectors so as to provide ionic conductivity between the active materials formed on the surfaces.

According to the opening formation method, the positive and negative current collectors may be classified into a punched metal type in which openings are formed on the current collector by pressing, an expanded metal type in which a notch is formed on the current collector and then expanded to either side to form openings, and an etched metal type in which the current collector is etched to form openings.

FIG. 1 shows a process of sequential steps of manufacturing a current collector by an etching method.

Referring to FIG. 1, a conventional method of manufacturing a current collector will now be described briefly.

First, an aluminum or copper foil used as the source material for a positive or a negative current collector is prepared (step S10). Then, the metal foil is degreased to remove impurities adhering to the surface thereof (step S20).

Next, a dry film resist is applied to one surface of the source material (step S30).

A photo mask having a pattern corresponding to openings is aligned on the source material having the film resist and then exposed to ultraviolet rays (step S40). When exposure is completed, the resultant structure is developed to form a pattern which is the same as that of each of the openings on the film resist (step S50).

Then, an etchant is uniformly coated on the source material to form the openings (step S60), after which, the film resist remaining on the source material is peeled off (step S70) and then dried at an appropriate temperature to complete a desired positive or negative current collector (step S80).

However, the conventional technology has the following problems.

According to the manufacture of an etched metal type current collector, a film resist is entirely applied to one surface of the source material for the positive or negative current collector, exposed, developed and then etched, that is, there are many processing steps, and the cost of production increases. Also, compared to other techniques, much more time is required for etching, which is not advantageous in view of the yield.

In the manufacture of an expanded metal type current collector, in a state in which a notched portion is formed on the current collector, since the direction of elongation coincides with the direction in which tension is applied, the current collector undergoes permanent deformation, which is not suitable for mass production based on a continuous fabrication process. Further, in the case where the current collector is cut into a predetermined size, burrs may be generated at cut portions, resulting in short-circuiting between the positive and negative electrode plates.

Since the source material for the current collector is a thin film of a metal foil in a punched metal type current collector, openings to be formed on the thin film are prone to deformation. Accordingly, when the sizes of openings are not properly adjusted, a plasticizer may not be extracted smoothly in a subsequent battery manufacturing process or the ionic conductivity may be deteriorated.

### SUMMARY OF THE INVENTION

To solve the above problems, it is a first objective of the present invention to provide an apparatus and method for manufacturing a current collector for a secondary battery, for effectively forming openings on positive and negative current collectors.

It is a second objective of the present invention to provide an apparatus and method for manufacturing a current collector for a secondary battery, in which patterns having the same shapes as openings to be formed on the current collector can be directly printed on a source material for a current collector using general gravure printing or flexo printing, without need of an exposure or development step, and can then be etched and peeled off, leading to reduction of the cost of production and improvement of productivity.

To achieve the above objectives, there is provided a method for manufacturing a current collector for a secondary battery, the method including the steps of preparing a source material for a current collector, pre-treating the source material, passing the source material between two rollers, one of which has a patterned portion shaped like openings to be formed on the current collector, and coating a pattern forming composition on the source material, curing the pattern forming composition, etching the source material to form the openings, and removing the pattern forming composition remaining on the source material, thereby completing the current collector having openings.

In the step of coating a pattern forming composition on the source material, the pattern forming composition is preferably coated only on portions where the openings are not formed on one side of the source material, and is entirely coated on the opposite side of the source material.

Also, the pattern forming composition remaining on the patterned portion of the roller is preferably transferred to the source material.

Further, at least one of the rollers is partially immersed in a pattern forming composition storage unit to continuously supply the pattern forming composition to the patterned portion

According to another aspect of the present invention, there is provided an apparatus for manufacturing a current collector for a secondary battery, the apparatus including a main roller, a guide roller, rotatably coupled to the main roller, for guiding a current collector source material between the guide roller and the main roller to form patterns shaped like openings formed on the current collector source material, and a pattern forming composition storage unit, installed under the main roller, for supplying a pattern forming composition to the main roller.

The main roller preferably has a patterned portion having patterns shaped like openings formed on the current collector.

The patterns formed in the patterned portion preferably protrude from the surface of the main roller.

Also, the patterns formed in the patterned portion are preferably depressed in the surface of the main roller.

A scraper for removing any pattern forming composition adhering to a portion other than the patterned portion, for clean printing, may be further provided at the main roller.

In the present invention, the pattern forming composition may include an acid-resistant polymer which is a copolymerization product of a main chain forming monomer and an acid resistant acryl-based monomer, a water-resistant polymer which is a copolymerization product of a main chain forming monomer and a water-resistant acryl-based monomer, a coloring agent, a crosslinking agent and a solvent.

Alternatively, the pattern forming composition may include an aqueous acryl resin which is a copolymerization product of a main chain forming monomer, an acid resistant acryl-based monomer and a water-resistant acryl-based monomer, a coloring agent, a crosslinking agent and a solvent.

### BRIEF DESCRIPTION OF THE DRAWINGS

The above objectives and advantages of the present invention will become more apparent by describing in detail a preferred embodiment thereof with reference to the attached drawings in which:

FIG. 1 is a flow chart illustrating a process of manufacturing a conventional current collector for a secondary battery;

FIG. 2 is an enlarged perspective view of a portion of a general secondary battery;

FIG. 3 is a perspective view of a roller unit in a current collector manufacturing apparatus according to a first embodiment of the present invention;

FIG. 4 is a side view of the roller unit shown in FIG. 3;

FIG. 5 is a diagram in which steps of a process of forming the openings are represented by various functional elements of the current collector manufacturing apparatus;

FIG. 6 is a flow chart of a process of manufacturing the current collector using the roller unit shown in FIGS. 3 and 4;

FIG. 7 is a partially enlarged side view of the roller unit shown in FIGS. 3 and 4, showing a state, in which the opening patterns are formed on the source material for the current collector to be configured for gravure printing;

FIGS. 8A through 8C show a process of forming openings on a source material for a current collector according to an embodiment of the present invention, in which FIG. 8A is a cross-sectional view showing a state in which the source material having a composition for forming a pattern coated thereon, is etched, FIG. 8B is a cross-sectional view showing a state in which the source material shown in FIG. 8A has been etched, and FIG. 8C is a cross-sectional view showing a state in which openings are formed on the source material shown in FIG. 8B;

FIGS. 9A and 9B show an ill-adapted variation of the present invention, in which FIG. 9A is a cross-sectional view showing a state in which the source material coated with a pattern forming composition is etched, and FIG. 9B is a cross-sectional view showing a state in which the profile of the etched surface of the source material shown in FIG. 9A is eroded;

FIG. 10 is a perspective view of a current collector manufacturing apparatus according to a second embodiment of the present invention; and

FIG. 11 is a partially enlarged side view of a roller unit shown in FIG. 10, showing a state in which opening patterns are formed on the source material for the current collector to be configured for flexo printing.

### DESCRIPTION OF THE PREFERRED EMBODIMENTS

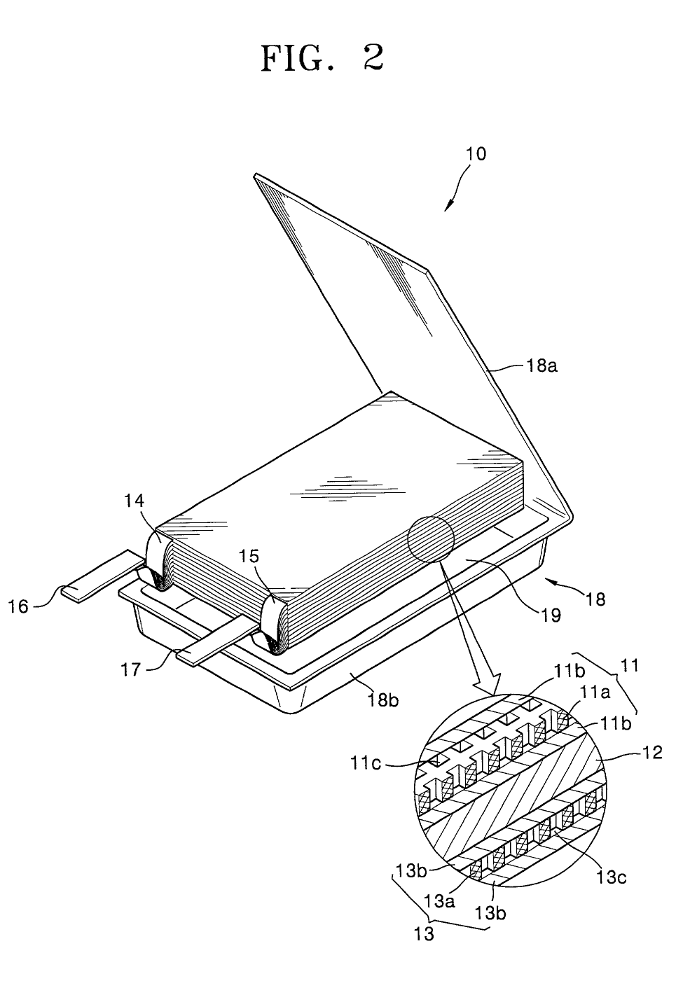

As shown in FIG. 2, a lithium polymer battery 10 as a secondary battery includes a battery unit having a plurality of electrode laminates, positive electrode plates 11, separators 12 and negative electrode plates 13 being sequentially disposed.

The positive electrode plate 11 includes a positive current collector 11a of a lamina such as an aluminum foil, and a positive sheet 11b adhered to at least one side of the positive current collector 11a. The positive sheet 11b includes a positive active material essentially composed of lithium oxide, which is mixed with auxiliary components such as a conductive material, a plasticizer, a binder or the like.

The negative electrode plate 13 includes a negative current collector 13a of a lamina such as a copper foil, and a negative sheet 13b adhered to at least one side of the negative current collector 13a. The negative sheet 13b includes a negative active material essentially composed of a carbonaceous material, which is mixed with auxiliary components such as a plasticizer, a conductive material, a binder or the like.

A positive tab 14 and a negative tab 15 extend outward at one side of each positive electrode plate 11 and each negative electrode plate 13, respectively. The positive tabs 14 are collected and bent in the shape of a wedge, and the ends thereof are welded to a positive electrode terminal 16. Likewise, the negative tabs 15 are collected, bent and welded to a negative electrode terminal 17.

The battery unit can be accommodated in a case 18 having a space 19. The case 18 is a pouch-like housing, and consists of an upper case part 18a and a lower case part 18b hinged to the upper case part 18a at its one side.

A novel feature of the present invention lies in that openings 11c and 13c are formed throughout the positive and negative current collectors 11a and 13a by a separate apparatus for forming openings.

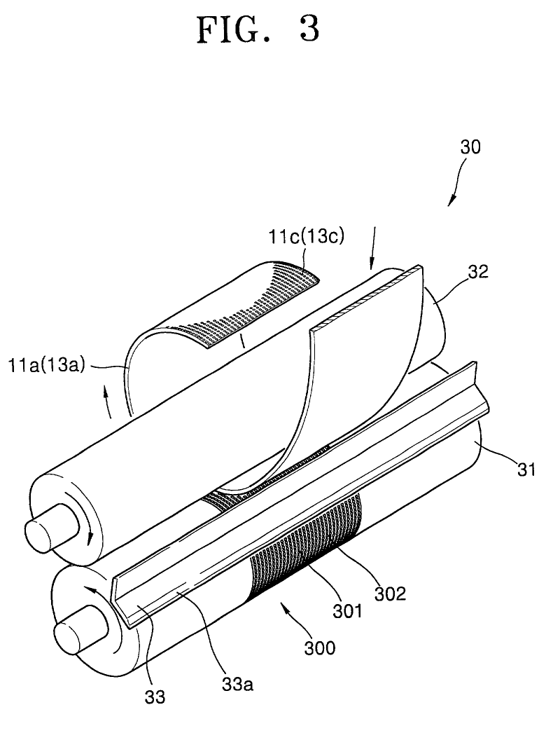

FIG. 3 shows a roller unit 30 in a current collector manufacturing apparatus for forming openings on a current collector. Referring to FIG. 3, the roller unit 30 includes a main roller 31 and a guide roller 32 rotatable in contact with the main roller 31.

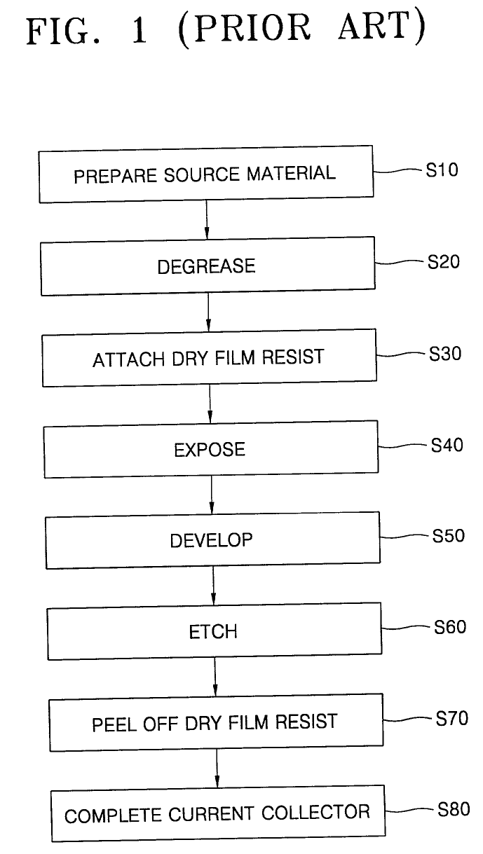

A source material for the positive or negative current collector 11a or 13a shown in FIG. 1, passes between the main roller 31 and the guide roller 32.

A patterned portion 300 is formed on the surface in the center of the main roller 31. The patterned portion 300 has a width corresponding to that of the source material for the current collector 11a (13a). The patterned portion 300 serves to pattern the openings 11c (13c) on one surface of the source material for the current collector 11a or 13c when the source material passes between the main roller 31 and the guide roller 32.

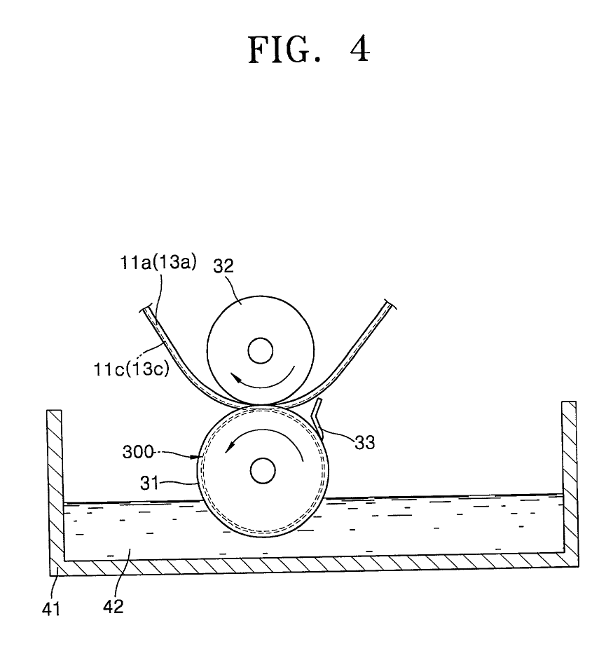

To this end, the patterned portion 300 has pattern grooves 301 shaped like the openings 11c (13c), in the form of a mesh. In the patterned portion 300, the respective pattern grooves 301 of the patterned portion 300 are engraved in the main roller 31 for performing gravure printing. The respective pattern grooves 301 temporarily store a predetermined amount of a pattern forming composition 42, which will later be described with reference to FIG. 4. The composition 42 is transferred to the source material for the current collector 11a (13a) when the source material passes between the main roller 31 and the guide roller 32.

The patterned portion 300 may be directly formed on the main roller 31. Alternatively, a mask having a pattern corresponding to the openings 11c (13c), may be adhered to the surface of the main roller 31.

The guide roller 32 is made of an elastic material, for example, rubber, so that the current collector 11a (13a) can be brought into perfectly tight contact with the patterned portion 300.

When the main roller 31 rotates, the pattern forming composition 42 supplied from a composition storage unit (41 of FIG. 4) is smeared all over the main roller 31, that is, even on a non pattern groove portion 302. If this state is left as it is, desired opening patterns cannot be attained on the source material for the current collector 11a (13a).

To prevent this, a scraper 33 for removing the pattern forming composition 42 adhering to the non pattern groove portion 302, is provided in contact with the main roller 31 in front of where the main roller 31 contacts the guide roller 32. An edge 33a of the scraper 33 is kept in close contact with the main roller 31 so that the pattern forming composition 42 adhering to the non pattern groove portion 302 of the main roller 31 may not remain on the surface of the main roller 31.

A process of forming the openings 11c (13c) on the source material for the current collector 11a (13a) using the above-described roller unit 30, will now be described.

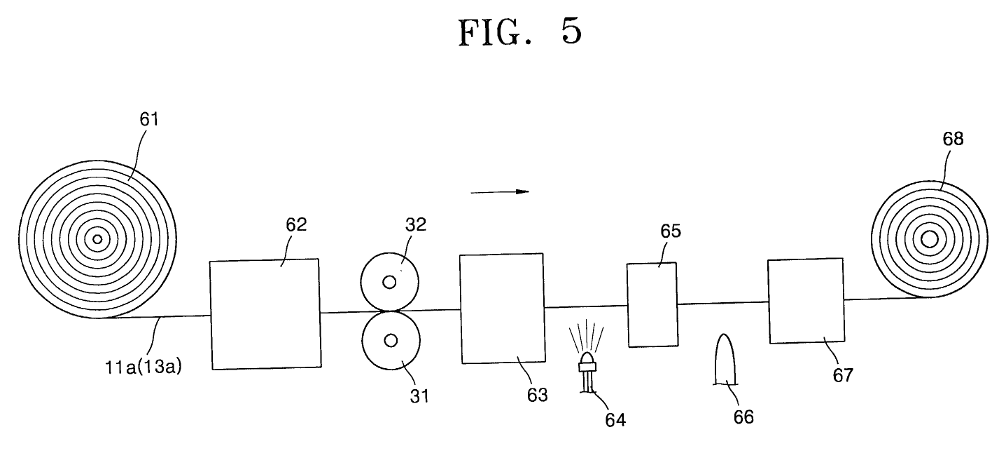

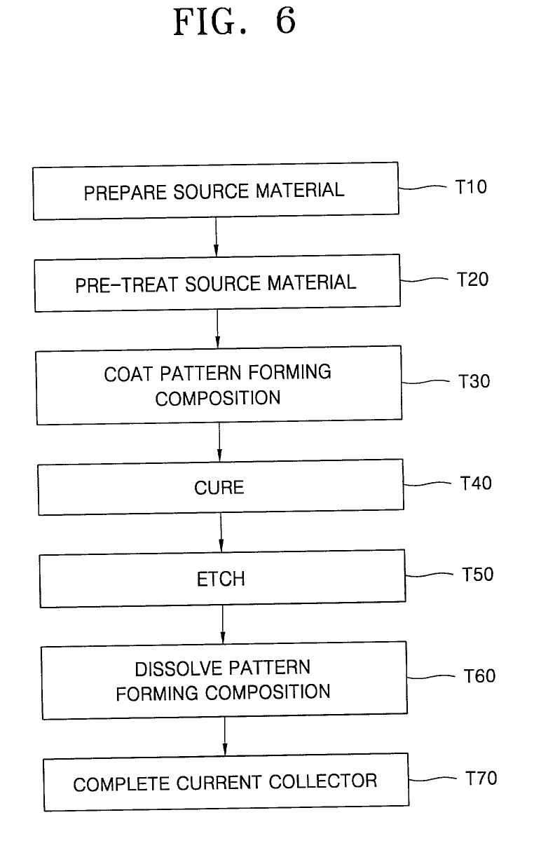

FIG. 4 shows an apparatus for forming openings 11c (13c) on the source material for the current collector 11a (13a) according to a first embodiment of the present invention, FIG. 5 is a diagram in which steps of a process of forming the openings 11c (13c) are represented by various functional elements of the apparatus shown in FIG. 4, and FIG. 6 is a flow chart of the opening forming process.

Referring to the drawings, a lamina such as an aluminum or copper foil to be used as the source material for the positive or negative current collector 11a or 13a is first prepared (step T10). Generally, the aluminum or copper foil is preferably wound around a supply reel 61 so as to be continuously supplied.

Then, in order to remove grease or impurities such as moisture or dust from the surface of the source material for the current collector 11a (13a), the prepared source material passes through a pre-treatment unit 62 to be washed or degreased (step T20).

After the pre-treatment, the pattern forming composition 42 is coated on the surface of the source material for the current collector 11a (13a) (step T30). In other words, the source material for the current collector 11a (13a), supplied from the supply reel 61, passes between the main roller 31 and the guide roller 32. Here, the patterned portion 300, having a portion of the openings 11c (13c), is formed on the main roller 31.

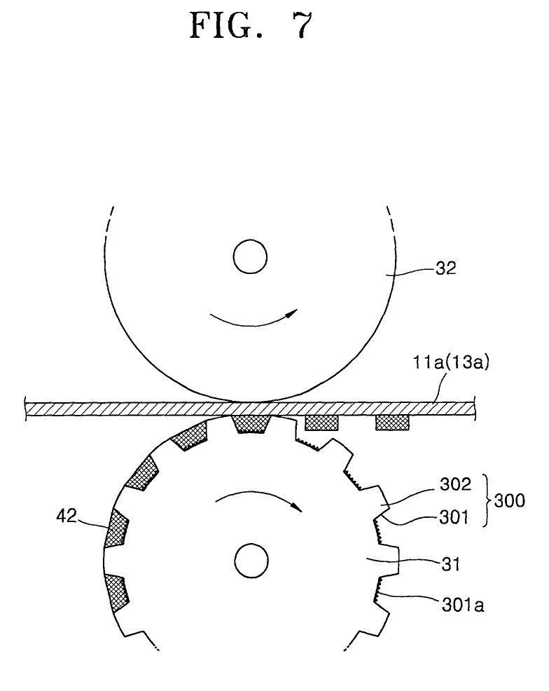

The main roller 31 rotates in a state in which it is constantly partially dampened with the pattern forming composition 42 stored in the composition storage unit 41. Accordingly, as shown in FIG. 7, the pattern forming composition 42 is supplied to the pattern grooves 301 formed on the main roller 31 to then be transferred to the source material for the current collector 11a (13a). Here, irregular unevenness 301a is preferably formed on the bottom surface of each of the pattern grooves 301 to facilitate storage of the pattern forming composition 42.

If the pattern forming composition 42 spills out of the pattern groove 301 and gets smeared on the non pattern groove part 302, it is difficult to form desired opening patterns on the source material for the current collector 11a (13a) unless the smeared composition 42 is removed. To avoid this, the scraper 33 is provided lengthwise with respect to the main roller 31. Accordingly, the pattern forming composition 42 smeared on the non pattern groove portion 302 and on the non patterned portion of the main roller 31 can be removed and withdrawn to the composition storage unit 41.

In such a manner, patterns of the openings 11c (13c) are formed on one side of the source material for the current collector 11a (13a). Also, another pattern forming composition 43 is coated on the entire surface of the opposite side of the source material having the opening patterns 11c (13c).

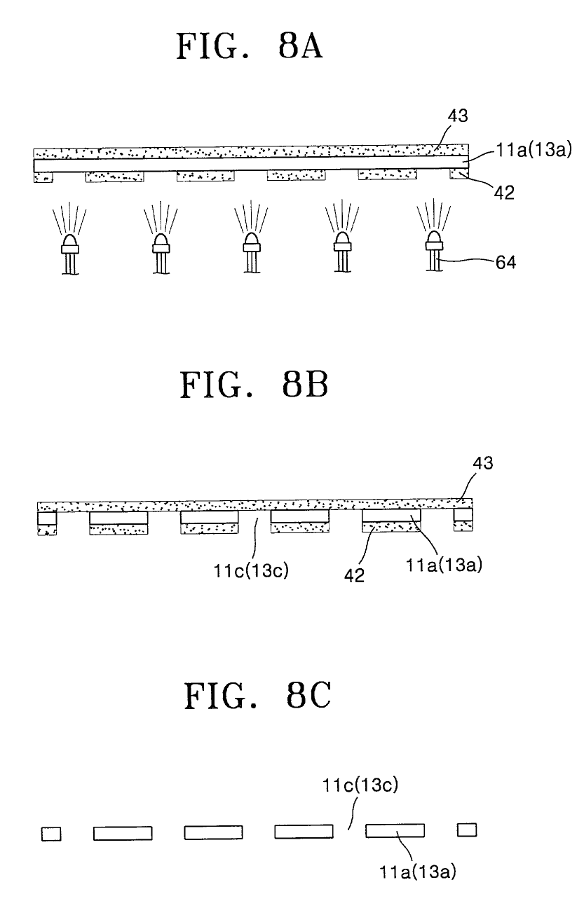

In other words, the pattern forming composition 42 to be used in forming the openings 11c (13c) is selectively coated on one side of the source material for the current collector 11a (13a), and a pattern forming composition 43, is coated on the entire surface of the opposite side of the source material for the current collector 11c (13c) (see FIG. 8A).

Coating the pattern forming composition 43 on one entire side of the source material may be performed before, after or simultaneously with selectively coating the composition 42 on the other side of the source material. When the pattern forming composition 43 used is in a solid phase (like a film), the coating of the pattern forming composition 43 is performed simultaneously with step T30, that is, the step of coating the pattern forming composition 42. When the pattern forming composition 43 used is in a liquid phase, the coating of the pattern forming composition 43 is preferably performed before or after step T30.

The thicknesses of the compositions 42 and 43 are preferably in the range of about 3 to about 10 μm, and more preferably, as thickly as possible within this range. If the thicknesses of the compositions 42 and 43 are less than about 3 μm, resistance against acid becomes poor; If greater than about 10 μm, the peeling time is undesirably prolonged.

Subsequently, the source material for the current collector 11a (13a) having the compositions 42 and 43 is cured in a curing unit 63 (step T50). Preferably, the curing temperature is in the range of about 60 to about 140° C. and the curing time is in the range of about 10 to about 20 seconds.

After the curing step, an etchant is uniformly coated on the resulting source material through a nozzle 64 (step T50). In the present invention, preferably, iron chloride (FeCl3) is used as the etchant, the etching temperature is in the range of approximately 30 to about 50° C. and the etching time is approximately 30 to about 60 seconds.

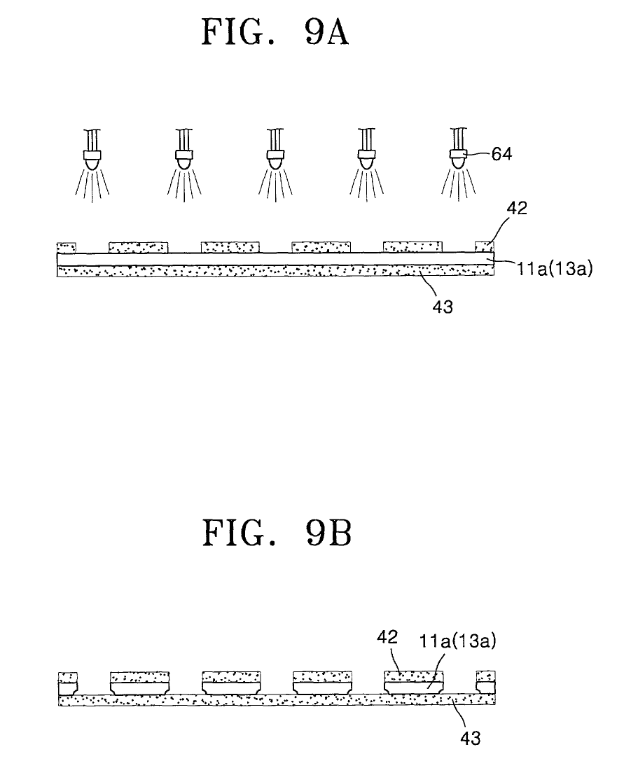

Here, the source material for the current collector 11a (13a) is disposed such that its surface having the pattern forming composition 42 faces downward, and one or more nozzles 64 are provided thereunder. This is to prevent erosion of the current collector 11a (13a) due to accumulation of etchant. In detail, in a case where the surface coated with the composition 42 faces upward, the opposite surface entirely coated with the composition 43 faces downward, and the etchant is sprayed downward from above the source material for the current collector 11a (13a), as shown in FIG. 9A. In this case, during etching, the etchant may collect on the bottom surface of the current collector 11a (13a) entirely coated with the composition 43, resulting in erosion around the lower portions of the walls of the openings formed in the source material for the current collector 11a (13a). Thus, as shown in FIG. 9B, the profile of an etched surface is not clean and may be eroded inward. In particular, since the current collectors 11a and 13a are thin films, they are very susceptible to erosion. Thus, the nozzles 64 are necessarily installed beneath the source material for the current collector 11a (13a).

In other words, the above-noted problem can be solved by spraying the etchant upward from the lower part of the source material for the current collector 11a (13a) through the nozzle 64, as shown in FIG. 8A. During etching, the etchant collides with the source material and then falls down by its own weight. Thus, the etchant does not accumulate, thereby preventing the erosion of the source material for the current collector 11a (13a). Accordingly, as shown in FIG. 8B, patterns of the openings 11c (13c) are produced in the source material for the current collector 11a (13a).

Then, the patterned source material is washed by a first cleaning unit 65. Subsequently, the pattern forming compositions 42 and 43 remaining on the source material for the current collector 11a (13a) are peeled off by a peeling agent sprayed from a nozzle 66, and thus removed (step T60). Here, a 4% NaOH aqueous solution is preferably used as the peeling agent.

After removal of the pattern forming compositions 42 and 43, the source material for the current collector 11a (13a) is washed at a second cleaning unit 67.

After the above-described process is completed, a separate post treatment process may be further performed according to the source material for the current collector 11a (13a). For example, in the case of a copper foil, an anti oxidation process may be performed to maintain a product performance requirement. Then, the patterned aluminum or copper foil is wound again on an accommodating reel 68. In some cases, the aluminum or copper foil may be cut into a predetermined size to be wrapped.

Then, the openings 11c (13c) of a desired size are formed in the source material for the current collector 11a (13a), thereby completing the current collector 11a (13a), as shown in FIG. 8C (step T70).

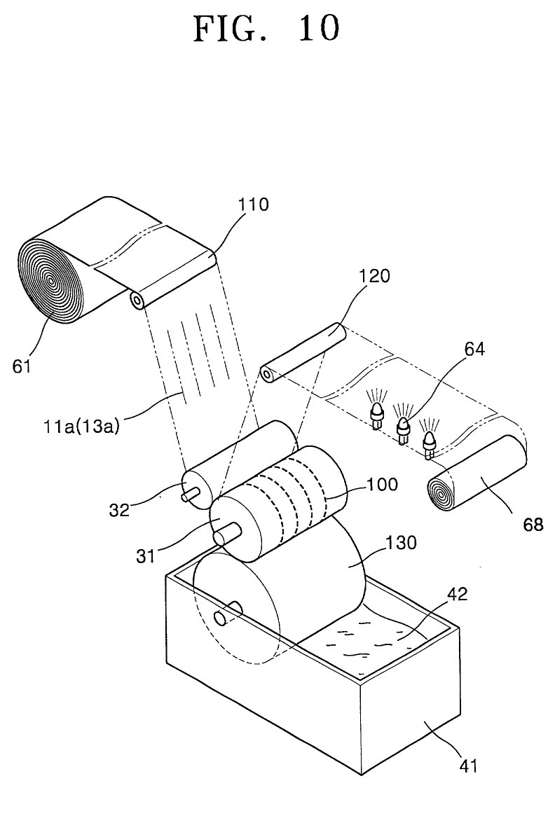

FIG. 10 shows an apparatus for forming openings 11c (13c) in the source material for a current collector 11a (13a) according to a second embodiment of the present invention. Here, the same reference numerals as those shown in the drawings for the first embodiment denote the same functional elements.

Referring to FIG. 10, a current collector 11a (13a) supplied from a supply reel 61 rounds a first support roller 110, passes between a guide roller 32 and a main roller 31, and then passes through a second support roller 120 to finally be wound around an accommodating reel 68.

Also, an ink supply roller 130 is rotatably coupled to and in contact with the main roller 31. The main roller 31 and the guide roller 32 are rotatably supported by support elements (not shown). A lower part of the ink supply roller 130 is immersed in a pattern forming composition 42 stored in a composition storage unit 41, so that the composition 42 can be continuously supplied to the main roller 31 as the ink supply roller 130 rotates.

A patterned portion 100 is formed on the surface of the main roller 31 and is in contact with the ink supply roller 130. Accordingly, the composition 42 supplied as the ink supply roller 130 rotates, is continuously applied to the main roller 31. The patterned portion 100 is configured to have a pattern corresponding to openings of the current collector 11a (13a).

The patterned portion 100 has protrusions for performing flexo printing. In other words, patterns of the patterned portion 100 protrude from the surface of the main roller 31. The surfaces of the patterns are dampened with the pattern forming composition 42.

A second support roller 120 which can alter the direction of the current collector 11a (13a), is installed along the path of the current collector 11a (13a) past the main roller 31 and the guide roller 32. One or more nozzles 64 are installed at the downstream side of the second support roller 120. Etchant is sprayed toward the current collector 11a (13a) from the nozzles 64.

A process of forming openings 11c (13c) in the source material for the current collector 11a (13a) using the above-described apparatus, will now be described.

The current collector 11a (13a) wound around the supply reel 61 is guided to a pre-treatment unit (not shown) as the supply reel 61 is unrolled, to then be washed. After the pre-treatment, the current collector 11a (13a) passes over the first roller 110 and then guided between the main roller 31 and the guide roller 32.

The patterns of the patterned portion 100 protrude from the surface of the patterned portion 100, so that the pattern forming composition 42 adhering to the surface of the ink supply roller 130 is transferred to the patterned portion 100. Here, the ink supply roller 130 is partially immersed in the composition storage unit 41 containing the pattern forming composition 42 so as to transfer the composition 42 to the main roller 31 as the ink supply roller 130 rotates. One side of the current collector 11a (13a) is partially coated with the composition 42 according to the shape of the patterned portion 100 and the opposite side thereof is entirely coated with a pattern forming pattern (not shown).

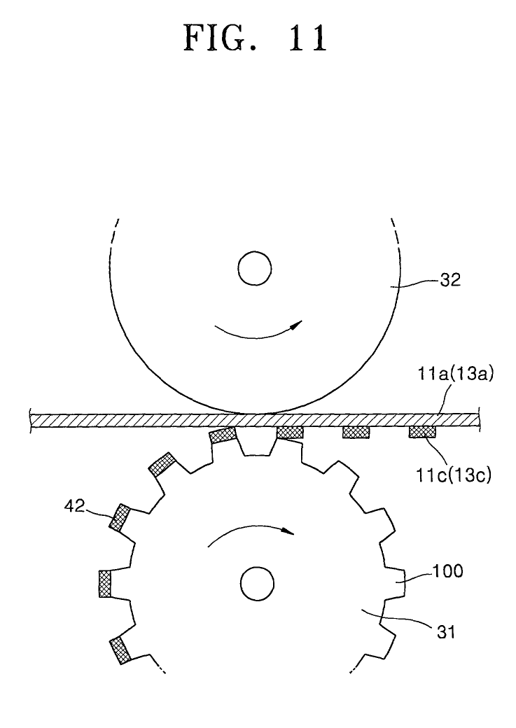

As shown in FIG. 11, the respective patterns of the patterned portion 100 are configured to protrude from the surface of the main roller 31, and the pattern forming composition 42 is applied thereto. Accordingly, the pattern forming composition 42 is transferred to the source material for the current collector 11a (13a).

After coating the pattern forming composition 42 on the current collector 11a (13a) having passed between the main roller 31 and the guide roller 32, the current collector 11a (13a) wraps around the second support roller 120 to then be subjected to curing.

Here, the curing temperature is preferably in the range of about 60 to about 140° C. and the curing time is preferably in the range of about 10 to about 20 seconds. Then, an etchant is uniformed sprayed on the patterned source material from nozzles 64 to perform etching. Here, one or more nozzles 64 are disposed under the current collector 11a (13a) and the etchant is sprayed upward therefrom.

After the opening patterns are formed by etching, the pattern forming composition 42 remaining on the source material for the current collector 11a (13a) is peeled off. Then, the current collector 11a (13a) is wound again in the accommodating reel 68 to be stored.

After etching, followed by removal of the pattern forming composition 42, a separate post treatment may be further performed according to the source material used. Finally, the openings 11c (13c) each of a desired size are formed in the source material for the current collector 11a (13a), thereby completing the current collector 11a (13a).

The pattern forming composition of the current collector for a secondary battery according to the present invention includes an acid-resistant polymer which is a copolymerization product of a main chain forming monomer and an acid resistant acryl-based monomer, a water-resistant polymer which is a copolymerization product of a main chain forming monomer and a water-resistant acryl-based monomer, a coloring agent, a crosslinking agent and a solvent.

Alternatively, the pattern forming composition of a current collector for a secondary battery according to the present invention may include an aqueous acryl resin which is a copolymerization product of a main chain forming monomer, an acid resistant acryl-based monomer and a water-resistant acryl-based monomer, a coloring agent, a crosslinking agent and a solvent.

The pattern forming composition for a current collector can be directly printed on the current collector using gravure printing or flexo printing, without exposure and/or development, and can be etched and peeled off. Various components contained in the pattern forming composition, and a method for preparing the composition, will now be described in more detail.

The pattern forming composition of the current collector for a secondary battery according to the present invention includes an acid-resistant polymer which is a copolymerization product of a main chain forming monomer and an acid resistant acryl-based monomer, a water-resistant polymer which is a copolymerization product of a main chain forming monomer and a water-resistant acryl-based monomer, a coloring agent, a crosslinking agent and a solvent.

The acid-resistant polymer is excellent in acid resistance and fair or poor in alkali resistance, and is produced by copolymerization of about 50 to about 95 parts, or about 50 to about 70 parts, and especially about 70 to about 95 parts by weight of the main chain forming monomer; and about 5 to about 50 parts, or about 30 to about 50 parts, and especially about 5 to about 30 parts by weight of the acid-resistant acryl-based monomer.

“Water-resistant polymer” is a general term for a resin which has excellent alkali resistance and fair water resistance, and is produced by copolymerization of about 60 to about 99 parts, or about 60 to about 90 parts, and especially about 70 to about 99 parts by weight of the main chain forming monomer; and about 1 to about 40 parts, or about 10 to about 40 parts, and especially about 1 to about 30 parts by weight of the acid-resistant acryl-based monomer.

Here, the main chain forming monomer forms the backbone of a polymer, and includes about 5 to about 75 parts by weight of an aromatic vinyl monomer and about 20 to about 55 parts by weight of alkyl (meth)acrylate. The aromatic vinyl monomer is exemplified by styrene, and the alkyl (meth)acrylate is exemplified by methyl methacrylate and methyl acrylate.

Usable examples of the acid-resistant acryl-based monomer include an acrylic (meth)acrylate having a carboxyl (—COOH) group in the molecule. The water-resistant acryl-based monomer is a compound having an aromatic vinyl acrylate or a vinyl acrylate on its main chain and a hydroxy (—OH) group in its molecule, and is exemplified by hydroxy alkyl (meth)acrylate.

Specific examples of the hydroxy alkyl (meth)acrylate include hydroxyethylacrylate, hydroxypropylacrylate and hydroxyethylmethacrylate.

The mixing weight ratio of the acid-resistant polymer to the water-resistant polymer is preferably in the range of about 1:4 to about 4:1. If the acid-resistant polymer content exceeds the range, corrosion undesirably occurs to the surface of a current collector. If the acid-resistant polymer content falls short of the range, acid resistance becomes poor. The total content of the acid-resistant polymer and the water-resistant polymer is preferably in the range of about 1 to about 90 parts by weight, more preferably in the range of about 40 to about 60 parts by weight. If the total polymer content is less than about 1 part by weight, the composition exhibits weak acid resistance, and if greater than about 90 parts by weight, printing adaptability of the composition becomes poor.

The weight average molecular weights of the acid-resistant polymer and the water-resistant polymer are preferably in the range of about 10,000 to several millions, and the glass transition temperature of about the polymers are preferably in the range of about −40 to about 90° C.

As the crosslinking agent for crosslinking the acid-resistant polymer and the water-resistant polymer, aziridine is most preferred from the viewpoint of its low-temperature curability as an etching mask pattern layer. The content of the crosslinking agent is in the range of about 0.5 to about 50 parts, or about 1 to about 10 parts, and especially about 0.5 to about 5 parts by weight. If the content of the crosslinking agent is less than about 0.5 parts by weight, chemical resistance is deteriorated. If the content of the crosslinking agent is greater than about 5 parts by weight, storage safety and printing adaptability are degraded.

In the present invention, in order to facilitate reactivity in a crosslinking reaction between a polymer and a crosslinking agent, an acid catalyst such as sulfuric acid, stearic acid or derivatives thereof, secondary or tertiary amines, or salt containing a metal such as manganese, barium or zinc, can be employed as a catalyst, and such a catalyst is preferably used in an amount of about 0.1 to about 1 part by weight.

The coloring agent is added in order to improve distinguishability of the pattern forming composition, and examples thereof include organic pigments and inorganic pigments. The content of the coloring agent used is in the range of about 1 to about 20 parts by weight.

Usable solvents in the present invention include hydrocarbons, halogenated hydrocarbons, alcohols, ethers, ketones, esters, poly alcohols, fatty acids, nitrogenous compounds, sulfur, phosphorus-containing compounds and inorganic solvents, and are preferably used in an amount of about 5 to about 80 parts by weight.

In the pattern forming composition for a current collector according to the present invention, various additives are added for the purpose of shortening a time required for forming coating layers formed of the composition while lowering the formation temperature, improving the surface state of the coating layer and other purposes. Here, examples of such additives include a leveling agent, e.g., silicon, high melting point ketone or ester, a foaming agent, e.g., azodicarbonamide (ADCA), and an anti foaming agent, and are preferably used in an amount of about 5 parts by weight or less. If the content of the additives used is greater than about 5 parts by weight, the coating layers are impossible to form due to a difference in surface tension, various adverse effects such as set-off, eyehole and cratering are generated. Also, recoating is difficult and phase separation unfavorably occurs.

Alternatively, the pattern forming composition of a current collector for a secondary battery according to the present invention, may have the following constituents. In other words, the composition of the present invention may include an aqueous acryl resin which is a copolymerization product of a main chain forming monomer, an acid resistant acryl-based monomer and a water-resistant acryl-based monomer, a coloring agent, a crosslinking agent and a solvent. In some cases, an ethylene modified unsaturated monomer may be further added when preparing the aqueous acryl resin.

The content of the main chain forming polymer is in the range of about 25 to about 130 parts by weight, the content of the acid-resistant acryl-based monomer is in the range of about 1 to about 40 parts by weight, and the content of the water-resistant acryl-based monomer is in the range of about 1 to about 40 parts by weight. Here, the main chain forming polymer consists of about 5 to about 75 parts by weight of an aromatic vinyl monomer and about 20 to about 55 parts by weight of alkyl (meth)acrylate.

Preferably, the aqueous acryl resin has an acid number in the range of about 30 to about 250 and a glass transition temperature of about −40 to about 90° C. The weight average molecular weight of the aqueous acryl resin is in the range of about 10,000 to several millions, and the content thereof is in the range of about 1 to about 80 parts by weight, more preferably about 40 to about 60 parts by weight. Here, if the content of the aqueous acryl resin is less than about 1 part by weight acid, resistance is weak. If greater than about 80 parts by weight, printing adaptability becomes undesirably deteriorated. The content of the crosslinking agent is in the range of about 1 to about 10 parts by weight, and the content of the solvent is in the range of about 5 to about 80 parts by weight.

Now, the present invention will be described in further detail with reference to Examples.

### EXAMPLE 1

50 parts by weight of water was added to 5 parts by weight of styrene, 25 parts by weight of methyl methacrylate and 20 parts by weight of acrylic acrylate, and 2 parts by weight of benzoylperoxide (BPO) as a polymerization catalyst was added thereto to then carry out polymerization at 85° C. for 6 hours, thereby synthesizing an acid-resistant polymer having a weight average molecular weight of about 300,000 to about 800,000.

Separately, 50% by weigh of water and 5 parts by weight of methacrylic acid were added to 20 parts by weight of styrene, 25 parts by weight of methyl methacrylate and 0.5 parts by weight of hydroxy propyl acrylate, and 2 parts by weight of BPO as a polymerization catalyst was added thereto to then carry out polymerization at 85° C. for 6 hours, thereby synthesizing a water-resistant polymer having a weight average molecular weight of about 300,000 to about 800,000.

20 parts by weight of the acid-resistant polymer and 28 parts by weight of the water-resistant polymer were mixed, and then 3 parts by weight of aziridine as a crosslinking agent, 8 parts by weight of a pigment, 0.3 parts by weight of aminomethyl propane as a crosslinking catalyst, 1 part by weight of wax and 38 parts by weight of a mixed solvent of water and ethanol were added thereto and mixed, thereby preparing a pattern forming composition.

A copper current collector was manufactured using the pattern forming composition in the following manner.

The surface of a source material for a copper current collector was degreased, the source material was passed between rollers, one of which has patterns shaped like openings to be formed on the current collector and the composition was coated on the copper current collector. Thereafter, the resultant was dried at 120° C. and then FeCl₃ as an etchant was sprayed over both entire surfaces of the copper current collector, that is, etching was performed. Then, the pattern forming composition remaining on the current collector was removed using a 4% NaOH aqueous solution, thereby completing the copper current collector having openings.

### EXAMPLE 2

45 parts by weight of water was added to 0.3 parts by weight of hydroxy ethyl acrylate, 13 parts by weight of styrene, 26 parts by weight of methylmethacrylic acrylate, 10 parts by weight of acrylic acrylate, 2.5 parts by weight of methylacrylic acrylate, and 2 parts by weight of an ethylene unsaturated monomer, e.g., M305, available under the trade name of Aronix™ M305 by Toagosei Chemical Industries, and 3 parts by weight of BPO as a polymerization catalyst was added thereto to then carry out polymerization at 85° C. for 5 hours, thereby synthesizing an aqueous acryl resin.

48 parts by weight of the aqueous acryl resin having a weight average molecular weight of 300,000 to 800,000, was mixed with 3 parts by weight of aziridine as a crosslinking agent, 8 parts by weight of a pigment, 0.3 parts by weight of aminomethyl propane as a crosslinking catalyst, 1 part by weight of wax and 38 parts by weight of a mixed solvent of water and ethanol, to then perform a crosslinking reaction, thereby preparing a pattern forming composition. A copper current collector was completed using the composition in the same manner as in Example 1.

### COMPARATIVE EXAMPLE 1

25 parts by weight of a polyamide resin having a weight average molecular weight of about 100,000 to about 300,000, 40 parts by weight of nitrocellulose, 20 parts by weight of a maleic resin and 10 parts by weight of a pigment, e.g., yellow D-581, were mixed to prepare a composition for gravure printing. A copper current collector was manufactured using the composition in the same manner as in Example 1.

### COMPARATIVE EXAMPLE 2

70 parts by weight of a urethane resin having an NCO group, 20 parts by weight of acryl polyol and 10 parts by weight of a pigment, e.g., yellow D-581, were mixed to prepare a composition for gravure printing. A copper current collector was manufactured using the composition in the same manner as in Example 1.

### COMPARATIVE EXAMPLE 3

60 parts by weight of polyvinyl chloride, 30 parts by weight of a maleic resin and 10 parts by weight of a pigment, e.g., yellow D-581, were mixed to prepare a composition for gravure printing. A copper current collector was manufactured using the composition in the same manner as in Example 1.

### COMPARATIVE EXAMPLE 4

60 parts by weight of glycidyl methacrylate, 30 parts by weight of a polymer obtained by modifying an epoxy resin using a maleic acid, that is, a resin produced by an ester reaction of an —OH group in the epoxy resin and a —COOH group in the maleic acid, the resin having a double bond, and 10 parts by weight of a pigment, e.g., yellow D-581, were mixed to prepare a composition for gravure printing. A copper current collector was manufactured using the composition in the same manner as in Example 1.

In manufacturing copper current collectors according to Examples 1 and 2 and Comparative Examples 1-4, the properties of the pattern forming composition and gravure printing composition were evaluated, and graded from 1 to 5, 1 being the worst and 5 being the best.

(1) Bonding property between a coating layer formed of the composition and source material for a copper current collector

The bonding property between a coating layer formed of a pattern forming composition and a source material for a copper current collector was evaluated by a scratch tape peeling test. The scratch tape peeling test was carried out such that a scratch tape was adhered to a printing plane and abruptly peeled off to test whether the coating layer was transferred to the tape.

(2) Chemical resistance

The chemical resistance was evaluated by inspecting the state of a pattern forming composition formed on a copper current collector after dipping it into a FeCl₃ solution as an etchant at 25° C. for 3 minutes.

(3) Peelability

The peelability of a pattern forming composition was evaluated by inspecting the state of the composition after dipping it into a 4% NaOH aqueous solution as a stripping solution at 35 to 40° C. for about 2 minutes.

(4) Printing adaptability

The shape of printed matter, for example, circular or prismatic, was examined and compared with the original pattern used for printing by the naked eye.

(5) Water resistance

To compare stripping extent of a coating layer formed of the compositions, the coating layers were immersed in ion exchange water at 40 to 50° C. for 10 to 60 minutes.

The evaluation results for the bonding property, chemical resistance, peelability, printing adaptability and water resistance tests are shown in Table 1.

TABLE 1

| | Bonding | Chemical | Peel- | Printing | Water |
|---|---|---|---|---|---|
| | property | resistance | ability | adaptability | resistance |
| Example 1 | 5 | 5 | 4 | 5 | 5 |
| Example 2 | 5 | 4-5 | 5 | 4-5 | 5 |
| Comparative | 5 | 3 | 5 | 5-4 | 3 |
| Example 1 | | | | | |
| Comparative | 5 | 2 | 5 | 5 | 2 |
| Example 2 | | | | | |
| Comparative | 5 | 3 | 4 | 4-3 | 3 |
| Example 3 | | | | | |
| Comparative | 5 | 4 | 3 | 3-2 | 5 |
| Example 4 | | | | | |

It is confirmed from Table 1 that the current collectors manufactured by Examples 1 and 2 have excellent chemical resistance and substantially the same bonding property, peelability, printing adaptability and water resistance, compared with the current collectors manufactured using prior art gravure printing compositions like in Comparative Examples 1-4.

Also, according to Examples 1 and 2, the processing steps can be greatly reduced, that is, there is no need to perform steps of attaching a dry film resist onto the current collector surface, exposing and developing, thereby increasing the processing speed.

As described above, in the apparatus and method for manufacturing a current collector for a secondary battery according to the present invention, openings are formed on positive and negative current collectors respectively used in positive and negative electrode plates by passing the current collectors between rollers, one of which has patterns shaped like openings to be formed on the current collectors to transfer the patterns to the current collectors, and then etching. Thus, according to the present invention, the following effects can be attained.

First, since a pattern forming composition is transferred using a roller having patterns shaped like openings, without steps of attaching a dry film resist onto the current collector surface, exposing, developing and etching, expensive source materials such as dry film resists are not necessarily consumed. Also, since exposure and development are not performed, the processing steps are reduced, which is advantageous from the viewpoint of manufacture yield.

Second, since burrs, which frequently occur at the end of expanded metal when cutting a reel-type current collector into a desired size, are not generated, therefore short circuiting between a positive electrode plate and a negative electrode plate can be prevented.

Third, since the sizes of openings formed on the current collector are adjusted as desired, a plasticizer extraction step in the process of manufacturing a battery can be smoothly performed.

Fourth, since during etching, an etchant is sprayed through nozzles upward from the lower part of the current collector, erosion can be prevented from occurring around the lower portions of the walls of the openings formed in the source material for the current collector.

Fifth, the patterns formed of a pattern forming composition exhibit excellent bonding ability with respect to a source material for the current collector, as well as excellent chemical resistance, water resistance and printing adaptability, and can be easily peeled off.

The various numerical ranges describing the invention as set forth throughout the specification also include any combination of the lower ends of the ranges with the higher ends of the ranges set forth herein, or any single experimental value or other single value set forth herein that will extend or reduce the scope of the lower limits of the range, or the higher limits of the range, where the ranges include, inter alia, ranges of time, temperature, concentrations of compounds, ratios of these compounds to one another, molecular species, molecular weights, pH, ratios of polymer units or polymer blocks to one another, average number of polymer units or polymer blocks in the polymer compounds of the invention, and the like, as well as all whole number and/or fractional number values encompassed by these ranges, and ranges encompassed within these ranges. The term “about” as it applies to individual numerical values, or numerical values stated in the ranges of the present specification means slight variations in these values.

Although the invention has been described with reference to specific embodiments and examples by way of illustration only, it will be appreciated that the scope of the present invention is intended to cover all modifications and equivalents within the scope of the appended claims. Accordingly, the true scope of the invention is intended to be defined only by the appended claims.

What is claimed is:

1. A method for manufacturing a current collector for a secondary battery, comprising the steps of:
preparing a source material for a current collector;
pre-treating the source material;
passing the source material between two rollers, one of which has a patterned portion shaped like openings to be formed on the current collector, and coating a curable pattern forming composition on the source material;
curing the pattern forming composition;
etching the source material to form the openings; and
removing the pattern forming composition remaining on the source material, thereby completing the current collector having openings.

2. The method according to claim 1, wherein in the step of coating a pattern forming composition on the source material, the pattern forming composition is coated only on portions where the openings are not to be formed on one side of the source material, and is entirely coated on the opposite side of the source material.

3. The method according to claim 2, wherein the pattern forming composition remaining on the patterned portion of the roller is transferred to the source material.

4. The method according to claim 3, wherein the patterned portion has depressions in the surface of the roller to temporarily store the pattern forming composition to be transferred to the source material.

5. The method according to claim 3, wherein the patterned portion has protrusions on the surface of the roller so that the pattern forming composition adhere to the protrusions to the surface of the source material to be transferred to the source material.

6. The method according to claim 2, wherein at least one of the rollers is partially immersed in a pattern forming composition storage unit to continuously supply the pattern forming composition to the patterned portion.

7. The method according to claim 1, wherein in the step of etching the source material to form openings, the side of the source material where the pattern forming composition is coated by the roller having the patterned portion, is disposed to face downward, and an etchant is sprayed upward toward the source material.

8. The method according to claim 7, wherein the current collector is etched in a reel-to-reel process.

9. An apparatus for manufacturing a current collector for a secondary battery, the apparatus comprising:
a main roller;
a guide roller, rotatably coupled to the main roller, for guiding a current collector source material between the guide roller and the main roller to form patterns shaped like openings formed on the current collector source material; and
a pattern forming composition storage unit, installed under the main roller, for supplying a pattern forming composition to the main roller.

10. The apparatus according to claim 9, wherein the main roller has a patterned portion having patterns shaped like openings formed on the current collector.

11. The apparatus according to claim 10, wherein the patterns formed in the patterned portion protrude from the surface of the main roller.

12. The apparatus according to claim 10, wherein the patterns formed in the patterned portion are depressed in the surface of the main roller.

13. The apparatus according to claim 9, further comprising an ink supply roller in contact with the patterned portion, for continuously supplying the pattern forming composition to the patterned portion.

14. The apparatus according to claim 9, wherein a scraper for removing any pattern forming composition adhering to a portion other than the patterned portion, for clean printing, is further provided at the main roller.

15. The apparatus according to claim 9, wherein a nozzle unit for spraying an etchant upward toward the source material, is further provided under the source material having the patterns.

16. The apparatus according to claim 9, wherein the pattern forming composition includes an acid-resistant polymer which is a copolymerization product of a main chain forming monomer and an acid resistant acryl-based monomer, a water-resistant polymer which is a copolymerization product of a main chain forming monomer and a water-resistant acryl-based monomer, a coloring agent, a crosslinking agent and a solvent.

17. The apparatus according to claim 16, wherein in the pattern forming composition, the total content of the acid-resistant polymer and the water-resistant polymer is in the range of about 1 to about 90 parts by weight, the content of the coloring agent is in the range of about 1 to about 20 parts by weight, the content of the crosslinking agent is in the range of about 0.5 to about 50 parts by weight, and the content of the solvent is in the range of about 5 to about 80 parts by weight.

18. The apparatus according to claim 16, wherein the main chain forming monomer includes about 5 to about 75 parts by weight of an aromatic vinyl monomer and about 20 to about 55 parts by weight of alkyl (meth)acrylate, the acid-resistant acryl-based monomer is acrylic (meth)acrylate and the water-resistant acryl-based monomer is hydroxy alkyl (meth)acrylate.

19. The apparatus according to claim 16, wherein;
(a) in the acid-resistant polymer the content of the main chain forming monomer is in the range of about 70 to about 95 parts by weight and the content of the acid-resistant acryl-based monomer is in the range of about 5 to about 30 parts by weight;
(b) in the water-resistant polymer, the content of the main chain forming monomer is in the range of about 70 to about 99 parts by weight and the content of the water-resistant acryl-based monomer is in the range of about 1 to about 30 parts by weight; and
(c) the total content of the acid-resistant polymer and the water-resistant polymer is in the range of 1 to 90 parts by weight.

20. The apparatus according to claim 16, wherein the mixture ratio of the acid-resistant polymer to the water-resistant polymer is in the range of 1:4 to 4:1.
